(19) United States
(12) Patent Application Publication
(10) Pub. No.: US 2013/0068487 A1
(43) Pub. Date: Mar. 21, 2013

(54) FIRE PROTECTION ELEMENT

(71) Applicant: Hilti Aktiengesellschaft, Schaan (LI)

(72) Inventors: Manfred KLEIN, Kaufering (DE); Herbert Muenzenberger, Wiesbaden (DE)

(21) Appl. No.: 13/622,211

(22) Filed: Sep. 18, 2012

(30) Foreign Application Priority Data
Sep. 19, 2011 (DE) 10 2011 082 911.3

(51) Int. Cl. A62C 2/06; A62C 3/00

(52) U.S. Cl. 169/45; 169/48

(57) ABSTRACT

A fire protection element for a smoke-gas-proof and fire-resistant bulkheading of line lead-throughs is disclosed. The fire protection element has at least one flat molded body made of an elastically deformable material, which is made at least partially of an ash-forming and, if applicable, intumescent mixture, where at least one surface of the molded body is structured. The structured surface is formed by projecting elements that are arranged regularly or irregularly, which may be configured to be punctiform or linear. Such a fire protection element makes it possible to seal a component through-hole so that it is smoke-gas-proof and fire-resistant in the case of subsequent occupation by a line such as a cable or a pipe.

This application claims the priority of German Patent Document No. DE 10 2011 082 911.3, filed Sep. 19, 2011, the disclosure of which is expressly incorporated by reference herein.

### BACKGROUND AND SUMMARY OF THE INVENTION

The invention relates to a fire protection element for the fire-retardant sealing of cable and/or pipe lead-throughs.

These types of fire protection elements are used in particular with subsequent occupation by lines, such as cable or cable harnesses and pipes, through a component such as the ceilings, walls, or floors of a building.

In the event of a fire, in order to prevent fire from spreading from one area to another area through the device disposed in the component, a device with a housing is known for example from German Patent Document No. DE 103 26 775 A1 in which a lower intumescent pad and several upper intumescent pad strips arranged adjacent to one another are disposed. The upper intumescent pad strips each have a flexible section extending to the lower intumescent pad. In the case of the subsequent occupation of the device, the flexible sections are raised depending upon the width and position of the lines that are fed through. In the event of fire, the ambient temperature rises significantly, whereupon the intumescent material expands and the lead-through opening of the device is sealed.

The disadvantage of the known solution is that for example, in the case of an occupation of the device with several lines, especially if they have different outside diameters, until the intumescent material expands in the event of fire it is possible for smoke gas to penetrate into adjacent areas through the device. In particular, the passage of cold smoke, whose temperature essentially corresponds to the normal ambient temperature, is not prevented through the known device.

A device for receiving a line in a lead-through of a component with a jacket-like housing, with a two-piece sealing insert made of an elastically deformable material and with a receiving area for the line is known from Patent Document No. GB 2 324 587 A. The housing includes two half shells in each of which a part of the sealing insert is disposed as a half shell. When the device is in an assembled state, the elastically deformable sealing insert completely surrounds the line accommodated in the receiving area and/or fed through the component and seals off the lead-through so that it is smoke-gas-proof.

The disadvantage of the known solution is that, in order to guarantee that it is smoke-gas-proof, only one line with a specific diameter can be fed through the device. In addition, a subsequent occupation of the device disposed in the component with additional lines is not possible.

German Patent Document No. DE 10 2004 056 914 A1 discloses a dimensionally stable deformable fire protection element made of an intumescent foamed material to seal a pipe and/or cable lead-through so that it is heat and/or fire-resistant, which is configured to be elongated, preferably cylindrical or bar-shaped, wherein the fire protection element is laid transverse to the pipe and/or cable in the pipe and/or cable lead-through.

The disadvantage of this known solution is that free space remains between the lead-through and the fire protection element, through which the smoke-gas is able to penetrate, before the fire protection element seals these free spaces through intumescence. In order to prevent this, the free spaces must be sealed with a sealing compound, which requires additional material and another work step.

Fire protection bricks are known from German Patent Document No. DE 199 14 371 C1, which are shaped and dimensioned like regular bricks and are used to seal off larger line lead-throughs.

The disadvantage of this is that, in order to seal lines so they are fireproof, the contour of the element that is fed through must be transferred to the corresponding fire protection block so that there is an accurate fit. Depending upon the shape and number of elements to be fed through, this work is correspondingly laborious. A further disadvantage arises when installing the last row of bricks. Frequently in this case, the height of a brick must be adjusted or trimmed. Insertion is often difficult, because, for one, the flanks of the brick are usually closely fit and, secondly, the brick is made of a polymer plastic that produces a corresponding frictional resistance.

A disadvantage with known fire protection elements that are used for sealing line lead-throughs arises furthermore during the fire testing of lines that conduct a lot of heat. Here the insulation and/or the heat dissipation of the fire protection element alone are not adequate in some cases and additional insulation measures must be taken. Normally, the additional insulation is accomplished by means of a fire protection mat, which is laid around the corresponding element. This mat is fabricated from different material than the fire protection element. In addition, one-sided installation is almost impossible particularly at locations that are difficult to access.

The object of the invention is creating a fire protection element for receiving at least one line in a lead-through of a component, which avoids the cited disadvantages, and that permits in particular a smoke-gas-proof and fire-resistant bulkheading of lead-throughs even when several lines are fed through.

This object is attained in that a fire protection element having at least one flat molded body is made available, wherein at least one surface of the flat molded body made of an elastically deformable material, which is made at least partially of an ash-forming and, if applicable, intumescent mixture, is structured, i.e., the surface is provided with elevations and depressions.

“Flat” within the meaning of the invention means that the plane of the molded body has a greater dimension than its thickness.

“Elastically deformable material” within the meaning of the invention means that the material is so flexible that it can be laid for instance around a line such as a pipe or cable without it cracking or breaking; furthermore, the material assumes its original shape again when it is deformed for example by compression, bending or twisting.

The term “line” or “line element” is used in the present description as a generic term for cable including cable bundles and pipes including bundles of pipe.

Because of the structured surface, it is possible for the fire protection element to be applied to a line and adequately seal the line without the contour of the line having to be cut out of the fire protection element beforehand. The elastic and deformable property of the material makes it possible for the elevations adjacent to the line to either compress, thereby widening the compressed elevations, or be pushed away to the side. Together with a further fire protection element, preferably a fire protection element according to the invention, wherein a fire protection element in another form, such as a brick for instance, may be used, an adequate smoke-gas-proof sheathing of the line is achieved hereby via the length of the line that is covered with the fire protection element(s). Because of the elasticity of the material of the fire protection element, it may also simply be wound around a line, wherein, depending upon the circumference of the line or in the case of a bundle of lines depending upon the circumference of the bundle, an appropriate length of the fire protection element is selected so that the line or the bundle of lines is completely enclosed in the circumferential direction. Because of the pliability of the material, additional fire protection elements, which have either the shape of bricks or the fire protection elements according to the invention, are able to be attached thereto without needing to be cut to size.

The flat molded body expediently has a rectangular block shape, wherein at least one of the base surfaces of the rectangular block is structured. The fire protection element according to the invention preferably has the shape and the dimensions of customary and commercially available fire protection bricks. In this case, the fire protection element may be made of one molded body or two molded bodies. Therefore, the fire protection element is able to be integrated in a simple manner into the bulkheading of a component opening without having to adapt the element. It is also possible to select the dimensions of the fire protection element according to the invention such that at least one molded body has the same base surface as a fire protection block, whose height is selected however such that two meshing molded bodies, which together yield one fire protection element, together yield the height of a fire protection block. As a result, it is possible to integrate the fire protection element according to the invention into a fire protection bulkhead as a subsequent occupation element for additional lines, which will be laid at a later point in time. Because of the structured surface, it is possible to insert lines in a simple manner without too much resistance through such a subsequent occupation element. The pliability and elasticity of the material make it possible for the elevations to yield when subsequently inserting a line so that insertion is able to be carried out without a lot of resistance and without great damage to the fire protection element. In cases where a pair of elevations is torn off during insertion of the line, this does not hinder the sealing properties of the fire protection element, because the remaining intact elevations ensure that it is adequately smoke-gas-proof and fire-resistant. In addition, the remaining elevations make it possible for the torn off elevations to get caught, which in turn produces sealing. In general, flat areas are produced at the locations where the elevations are torn off. The elasticity of the material now leads to the flat areas being able to adapt in terms of their shape to the line or the bundle of lines so that impermeability to smoke gas continues to be guaranteed.

A further advantage of the fire protection element according to the invention is that the last row of the bulkheading of a component opening may be set with fire protection blocks that have the fire protection element according to the invention, wherein adapting the fire protection elements to the surface structure of the component opening—for instance by cutting to size—is no longer required because of the structured surface of the fire protection element. The elevations of the surface of the fire protection element adapt to the structure of the component opening and seal the component opening against smoke gases. As a result, with adequate impermeability, it is possible to dispense with any required additional filling or sealing of the gap between the last brick row and the wall of the breakthrough with fire protection foam or another sealing compound. This results in lower labor and material costs. Another advantage is produced by the reduced friction of the structured surface at the component opening. Because of the reduced resistance compared to a fire protection element that has a flat surface, the fire protection element according to the invention is able to be inserted more easily into the component opening.

The fire protection element may also be configured as a mat so that it may be wound more easily and preferably in one piece around the lines. This is then advantageous in particular when additional thermal insulation is required in the case of lines that are highly heat-conductive, e.g., thick copper cables with thin insulation or metal pipes that are not insulated. The fire protection element is preferably wider than the required insulating distance for standard lines or for lines with low temperature control, so that it projects beyond it. The required insulating distance, i.e., the minimum insulating distance, in this case is a function of the line type (material, size) and the desired fire resistance or the fire resistance class to be achieved, such as F30, F60, F90, F120 or F180. However, a projection of approx. 5 cm over the minimum insulating distance on both sides suffices in most cases.

The structured surface of the molded body is expediently formed by projecting elements that are arranged regularly or irregularly, wherein a regular arrangement is preferred. The projecting elements are preferably arranged intermittently along imaginary lines on the base surface.

According to a preferred embodiment of the invention, the projecting elements themselves have different or similar geometries and/or dimensions. It is hereby ensured that several lines of different sizes are able to be laid next to one another without additional expense—for instance from cutting out fire protection blocks—and without impairing the fire protection function of the bulkheading.

With regard to simpler production, the configured elevations and depressions are expediently complementary. In the case of a fire protection element made of two molded bodies, in which the structured surfaces are facing one another, the structured surfaces are preferably complementary, i.e., the elevations and depressions engage in each other, wherein small gaps may remain. As a result, an especially good seal is achieved against the passage of smoke gases even if the structured surfaces are not 100% complementary.

The shape of the elevations and depressions of the structured surface of the molded body is not limited. The projecting elements are preferably pyramidal, conical, hemispherical, or nubby.

The elevations may be connected to each other by crosspieces as a function of the manufacturing process. Depending upon the planned use of the fire protection elements according to the invention, this may contribute to stability, such as, for example, in the case of use as fire protection bricks or as a mat. In particular, the height of the crosspieces corresponds to a maximum of half the height of the elevations so that a meshing of two fire protection elements that are arranged so that the structured surfaces are facing each other, is facilitated.

However, a fire protection element whose elevations are not connected by crosspieces is preferred especially for use of the fire protection elements according to the invention as wrapping. This has a direct impact on the flexibility of the fire protection element, wherein the fire protection elements are considerably more flexible without the crosspieces.

Alternatively, the structured surface may be formed by elevations and depressions in the form of grooves. The structured surface in this case is in particular undulated, trapezoidal, or wedge-shaped in the direction perpendicular to the corresponding plane of the fire protection element. This means that the elevations and the depressions together produce the respective shape. The expression “shape of the grooves/elevations” will be used for this in the following. The grooves may run in particular in an undulated, trapezoidal, or wedge-shaped manner in a direction parallel to the corresponding plane of the fire protection element. The expression “progression of the grooves/elevations” is used for this in the following. It should be noted that the structured surface is not limited to the shapes and progressions described here, but may assume any other shape and progression. The progression of the grooves or elevations relative to a lateral edge of the fire protection element is likewise not restricted. They may run parallel to a lateral edge but also at every angle to the lateral edge, e.g., diagonally, wherein the grooves or the elevations are respectively disposed parallel to one another. The elevations in this case may have the same or different heights in an alternating or irregular manner.

In the case of this alternative embodiment of the fire protection element according to the invention, the fire protection element may be present both in the form of a fire protection block as well as in the form of a fire protection mat.

In the case of large-scale fire protection elements, for instance with fire protection mats, whose grooves or elevations run diagonally, it may be advantageous in terms of impermeability to smoke gas to arrange these in rows, wherein one row is made up of parallel grooves or elevations and adjacent rows are slightly staggered in relation to each other so that the grooves or elevations are interrupted. In this case, the rows and consequently the grooves or elevations describe a stepped or zigzag course within the plane of the fire protection element. The fire protection mat is expediently used in such a way that the line comes to lie in the groove. The groove shape facilitates a simple adaptation of the fire protection element to different line diameters. If cable or pipe bundles as lines are wound with the fire protection element, the external gusset between the individual elements of the bundle is sealed by pressing against the fire protection element so that there is the greatest possible impermeability to smoke gas over the length of the fire protection bulkhead.

In the case of a fire protection block, it is preferably installed in a fire protection bulkhead in such a way that a line comes to lie in the groove. When using such a fire protection block as the final row of a fire protection bulkhead, it is preferably installed such that the grooves run in the direction of the breakthrough, because insertion of the fire protection block is hereby facilitated. Furthermore, the elevations are damaged less as a result. Particularly in terms of impermeability to smoke gas, fire protection blocks are preferably provided with diagonally running grooves or elevations. These fire protection blocks are expediently installed in a fire protection bulkhead in such a way that the grooves or elevations do not run in a line but are offset from one another. In this case, the fire protection blocks may be installed so they are offset or directly behind each other (in the direction of the breakthrough), wherein, in the latter case, the fire protection block is rotated in such a way that the progression of the grooves or elevations of adjacent fire protection blocks describes a zigzag line. The placement of the next row of fire protection blocks is carried out accordingly.

The sealing insert is preferably airtight so that even a state in which the sealing insert is not additionally compressed by the fed-through lines, no smoke gas and thus no cold smoke is able to penetrate through the device. The airtightness is ensured for example by an appropriate selection of the material for fabricating the sealing insert. Alternatively, the airtightness of the sealing insert may be guaranteed for example by a suitable coating or by a suitable covering of the surface of the sealing inserts, which furthermore guarantees elasticity of the elastically deformable material of the sealing insert.

Because of the structured surface, particularly the elevations and the elasticity of the molded body of the fire protection element according to the invention, it is also possible for lines to be installed in a simple manner in a fire protection bulkhead even when the fire protection element is in an assembled state. The elevations of the structured surface seal the fire protection bulkhead until it is occupied with lines. When feeding a line though, the elevations yield laterally and create the required free space for the line. The molded body is applied to the fed-through line and guarantees bulkheading against smoke gas even in the occupied state. When a line is removed, the molded body fills in the free space that is no longer needed, wherein the elevations realign as applicable. The fire protection element can be occupied repeatedly and no expendable material is required for installation. In addition, there is no contamination of the surrounding area during a subsequent occupation or removal of lines, something that is particularly advantageous when working in rooms that have already been completed.

In addition, the sealing insert is preferably fabricated from a foam. For example, the foam is foamed in a mold, which has a corresponding negative shape of the desired structured surface of the sealing insert. Alternatively, the sealing insert is cut from a block. The sealing insert is advantageously fabricated from an at least partially closed-celled foam, wherein a closed-celled foam is preferred, because it is completely airtight.

The molded body of the fire protection element according to the invention is preferably made of a foamable binding agent, which contains the ash-forming and, if applicable, intumescent mixture. The binding agent in this case serves as a compound-forming support for the ash-forming and, if applicable, intumescent mixture. It is preferred that the mixture be distributed homogeneously in the binding agent. The compound-forming support is preferably selected from the group made up of polyurethanes: phenolic resins, polystyrenes, polyolefins such as polyethylene and/or polybutylene, melamine resins, melamine resin foams, synthetic or natural rubber, cellulose, elastomers, and mixtures thereof, wherein polyurethanes are preferred.

The ash-forming and, if applicable, intumescent mixture includes standard fire protection additives known to a person skilled in the art which foam in the event of fire, i.e., with exposure to heat, and in doing so form a foam that inhibits flame propagation, such as an intumescent material based on an acidifier, a compound supplying a carbon and a gas former. The intumescent material preferably includes, as the acidifier, a salt or an ester of an inorganic, non-volatile acid selected from sulfuric acid, phosphoric acid, and boric acid; as the compound supplying carbon, a polyhydroxy compound and/or a thermoplastic or thermosetting polymer resin binding agent; and as the gas former, a chlorinated paraffin, melamine, a melamine compound, in particular melamine cyanurate, melamine phosphate, melamine polyphosphate, tris(hydroxyethyl)-cyanurate, cyanamide, dicyanamide, dicyandiamide, biguanidine and/or a guanidine salt, in particular guanidine phosphate or guanidine sulfate.

Furthermore, the compound-forming support as an ablative additive may be an inorganic compound, which has solidly incorporated water, e.g., as water of crystallization, and does not dry out at temperatures up to 100° C., but releases the water in the event of fire starting at 120° C. and is therefore able to cool parts subject to temperature, preferably an inorganic hydroxide or hydrate that releases water at the fire temperature or with the application of flame, in particular aluminum hydroxide, aluminum oxide hydrates or partially hydrated aluminum hydroxides. But other inorganic hydroxides or hydrates that release water with the application of flame come into consideration such as those described in European Patent Document No. EP 0 274 068 A2.

These types of compounds, which may be used as a mixture in the fire protection element according to the invention, are known to a person skilled in the art and are disclosed for example in the following patent documents, which are incorporated by reference herein: DE 30 25 309 A1, DE 30 41 731 A1, DE 33 02 416 A1, DE 34 11 327 A1, EP 0 043 952 B1, EP 0 051 106 B1, EP 0 061 024 B1, EP 0 116 846 B1, EP 0 158 165 B1, EP 0 274 068 A2, EP 1 347 549 A1, EP 1 641 895 B1 and DE 196 53 503 A1.

Their heat- and fire-resistant properties are produced in the event of a fire in that the fire protection element burns away on the outside and forms a layer of ash. This layer of ash then provides thermal insulation. What is important, however, in this case is that the layer of ash is as stable as possible so that it does not fall off of the rest of the fire protection element. This is achieved for example by chemical additives in the foamed material. In the case of large fire protection elements or large lead-throughs that need to be sealed, adequate mechanical stability of the ash crust itself as well as sufficiently stable adherence of the ash crust to the still unburned portion of the fire protection element must naturally be preserved even when there is advanced fire development.

In the case of fire protection elements, such as fire protection blocks, it is frequently observed that when there is advanced burn-off of the fire protection block, the ash that has already formed falls off or the still unburned portion of the fire protection block falls out of the bulkhead. For one, this can be attributed to the matrix softening in the event of fire, thereby enabling the intumescence of the additives to first take place. However, the zone of the softened matrix weakens the bond with the already formed ash crust. In addition, the intumescence may contribute to the still unburned portion of the fire protection block being pushed out of the bulkhead. This may become problematic particularly in the case of large ceiling bulkheads.

The weakening of the bond between the ash crust and the still unburned portion of the fire protection block can become a problem in the case of the hose stream test required in the U.S., in which the crust must be able to withstand a strong water stream after the fire.

In a further preferred embodiment of the fire protection element according to the invention, the molded body is therefore provided with a support element. This is then especially advantageous if, as mentioned above, additional insulation is required and the fire protection element projects beyond the required insulating distance and the breakthrough. In the process, the support element prevents the ash crust from falling off in the event of fire and thus the loss of the insulation. In addition, it is no longer necessary to support the projecting ends of the fire protection element with supportive external measures such as a frame in order to thereby prevent the insulating ash crust from falling off.

The support element should have a structure which ensures a connection between the ash crust and the still unburned portion of the fire protection element beyond the melting zone. This can be achieved by fibers or threads that are arranged next to one another such as a web or fabric for instance. The support part preferably has a grid structure. The support element is expediently made of a temperature-resistant material, wherein temperature-resistant means that the materials have a higher melting point than the binding agent. These types of materials are adequately known to a person skilled in the art and may be carbon, ceramic, basalt, mineral fibers, glass fibers, natural fibers and composites with plastics, wherein glass fibers are preferred. Even perforated sheeting, expanded metals, fabric made of metals such as aluminum, which are created in such a way that they do not impair the flexible and elastic properties of the fire protection element, may be used as the support element. It is preferred that those materials which permit a simple processing, such as cutting the fire protection element to size with a carpet knife, be used as the support element. The support element is preferably used in the insert, in that it is foamed into the molded body. The position of the support element is not limited, wherein it is preferred that the support element form an outer side or come to rest near an outer side of the fire protection element.

Production of the fire protection element according to the invention preferably takes place by foam molding in accordance with standard methods for the production of foamed molded bodies that are known to a person skilled in the art. The structured surface of the fire protection element is produced by molding. As a result, it is possible to structure the surface in a simple manner so that many geometries are conceivable and possible. Alternatively, it is also possible to process the foam subsequently, i.e., after production for instance of a foam block or a foam mat, to bring the block or the mat to the correct shape and size. For example, a foam block or foam mat is produced first of all using RIM (reaction injection molding), then the (flat) surfaces are structured by means of nubbed rollers and finally cut horizontal. Blocks or mats may obtain a structured surface in this way.

The fire protection element according to the invention may be produced in particular by a homogeneous mixture (preferably without a solvent in a solid state) of the ash-forming and, if applicable, intumescent mixture and the compound-forming support and subsequent foaming as the case may be.

A further subject matter of the invention is the use of the fire protection element just described as an insert for a device for receiving at least one line in a lead-through of a component.

Another subject matter of the invention is the device itself and therefore a device for receiving at least one line in a lead-through of a component with a jacket-like housing, with a sealing insert and with a receiving area for the at least one line, which is characterized in that the sealing insert is a fire protection element described above.

The sealing insert expediently has at least one structured surface projecting into the axial projection of the receiving area.

The sealing insert is provided in the housing in such a way that the structured surface forms the sealed receiving area for the lines. The elevations of the structured surface advantageously engage in the depressions, i.e., the spaces between the opposing elevations of the opposing sealing insert, when the sealing insert is in an assembled state. The sealing insert has a volume which corresponds at least to the volume formed by the jacket-like housing over the section in which the sealing insert is arranged.

The sealing insert is provided for example in a folded manner in the housing, wherein the sections of the structured surface face one another at least in areas and the receiving area for the at least one line is configured between the folds. The lines can be fed though between the folds of the sealing insert.

For example the sealing insert has an average height which corresponds to at least half of the corresponding inside dimension of the jacket-like housing. Therefore, the elastically deformable material is sufficiently well compressed in an assemble state even without any lines fed-through and bulkheading against smoke gas is ensured in an advantageous manner.

The sealing insert extends at least partially along the jacket-like housing. In addition, the device may have more than one sealing insert in the jacket-like housing, which are arranged for example spaced apart from one another in the feed-through direction of the device.

Because of the structured surface, particularly the elevations of the sealing insert and the elasticity of the sealing insert, it is also possible for lines to be installed in a simple manner in an assembled state of the device. The elevations of the structured surface seal the receiving area until it is occupied with lines. When feeding a line though, the elevations yield laterally and create the required free space for the line. The elastically deformable material is applied to the fed-through line and guarantees bulkheading against smoke gas even in the occupied state of the device. When a line is removed, the elastically deformable material fills in the free space that is no longer needed, wherein the nubs realign as applicable. The device can be occupied repeatedly and no expendable material is required for installation. In addition, there is no contamination of the surrounding area during a subsequent occupation or removal of lines because of the device, something that is particularly advantageous when working in rooms that have already been completed.

The sealing insert is fixed in the housing for example and is arranged in the component with the housing at the same time. Alternatively, in a first assembly step only the jacket-like housing of the device is arranged in the component and then the sealing insert is subsequently provided in the housing. In the case of the alternative variant, at least one sealing insert may also be arranged in the housing after at least one line has been fed through the housing.

The sealing insert may also have at least one jacket section, which advantageously grips around the outside of the elastically deformable material of the sealing insert at least in sections. Two jacket sections are especially advantageously provided, which are connected to each other for example via at least one articulated connection. The sealing insert is fixed at the at least one jacket section, for example by an adhesive connection. Such a sealing insert is provided for example in the case of lines which have already been fed through the jacket-like housing and is arranged in the housing by displacement. If the jacket-like housing is a tubular sleeve, the jacket sections of the sealing insert are advantageously formed as half-shells. If the sealing insert has two sealing elements, then a respective sealing element is advantageously provided on each jacket section, the surfaces of which are provided with elevations that face each other in the assembled state of the sealing insert, wherein the receiving area is configured between them for at least one line.

The jacket-like housing is advantageously a tubular sleeve and the average height of the sealing insert corresponds to at least half the inside diameter of the tubular sleeve. Due to the sleeve-like design of the housing and the height of the at least one sealing insert, the sealing insert is essentially uniformly compressed in the arranged state in the housing, thereby advantageously ensuring impermeability to smoke gas.

In a further embodiment of the device, the sealing insert has at least two sealing elements, each of which have a structured surface. The two sealing elements are arranged advantageously in the housing in such a way that, in the assembled state of the sealing elements, the structured surfaces thereof are facing one another.

The elevations of the structured surface are preferably arranged intermittently along lines of the jacket-like housing and advantageously form a two-dimensional structured surface of the sealing insert. The entire surface of the sealing element surrounding the receiving area is especially advantageously structured, wherein in particular the elevations of the structured surface are all arranged at the same distance from one another. The surface has an undulated design for example along a line running through several elevations arranged one after the other, wherein the crests of the undulations respectively form the elevations.

The opposing elevations are preferably configured to be complementary in relation to the receiving area. A labyrinthine seal is thereby created, which guarantees an advantageous bulkheading of the device against smoke gas. It is especially advantageous if adjacent elevations are arranged offset from one another.

The invention will be explained in more detail in the following on the basis of exemplary embodiments.

### BRIEF DESCRIPTION OF THE DRAWINGS

FIG. 1 is a schematic representation of a fire protection mat according to one embodiment;

FIG. 2 is a schematic side view of the fire protection mat from FIG. 1;

FIG. 3 is a schematic top view of the fire protection mat from FIG. 1;

FIG. 4 is a view of a first device according to the invention;

FIG. 5 is a section through a second device according to the invention that is arranged in a component; and

FIG. 6 is a plan view of a sealing insert of the second device according to the invention in an open state.

### DETAILED DESCRIPTION OF THE DRAWINGS

As a rule, the same parts are provided with the same reference numbers in the figures.

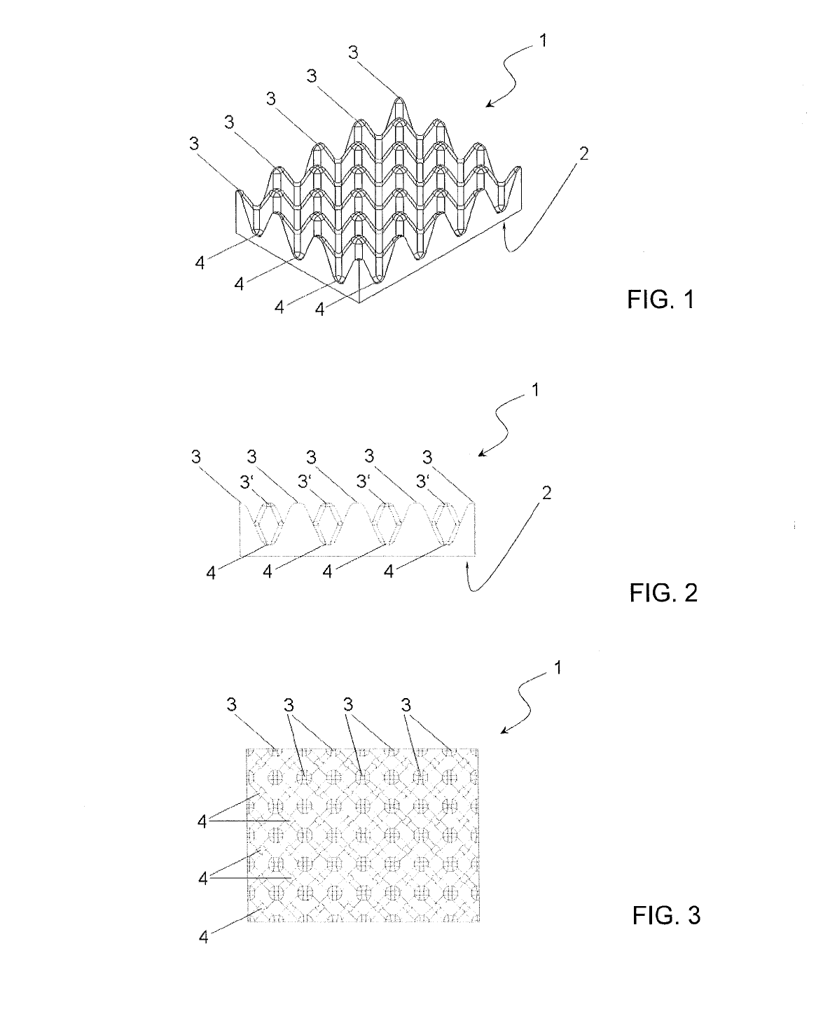

FIG. 1 shows a fire protection element 1 according to the invention in the form of a fire protection brick, the underside 2 of which is smooth and the surface of which is structured, wherein the elevations 3 and the depressions 4 are configured in the form of nubs. FIG. 2 is a side view of the fire protection brick from FIG. 1, which shows a regular structuring of the surface by elevations 3 and 3′ and depressions 4 in the form of nubs, wherein it is clear that the elevations of the second row 3′ are arranged offset from the elevations in the first row 3 so that, as viewed from the side, they lie in a line with the depressions 4 in the first row. The top view in FIG. 3 of the fire protection brick 1 from FIG. 1 clearly shows that the elevations 3 and the depressions 4 are arranged in a regular manner.

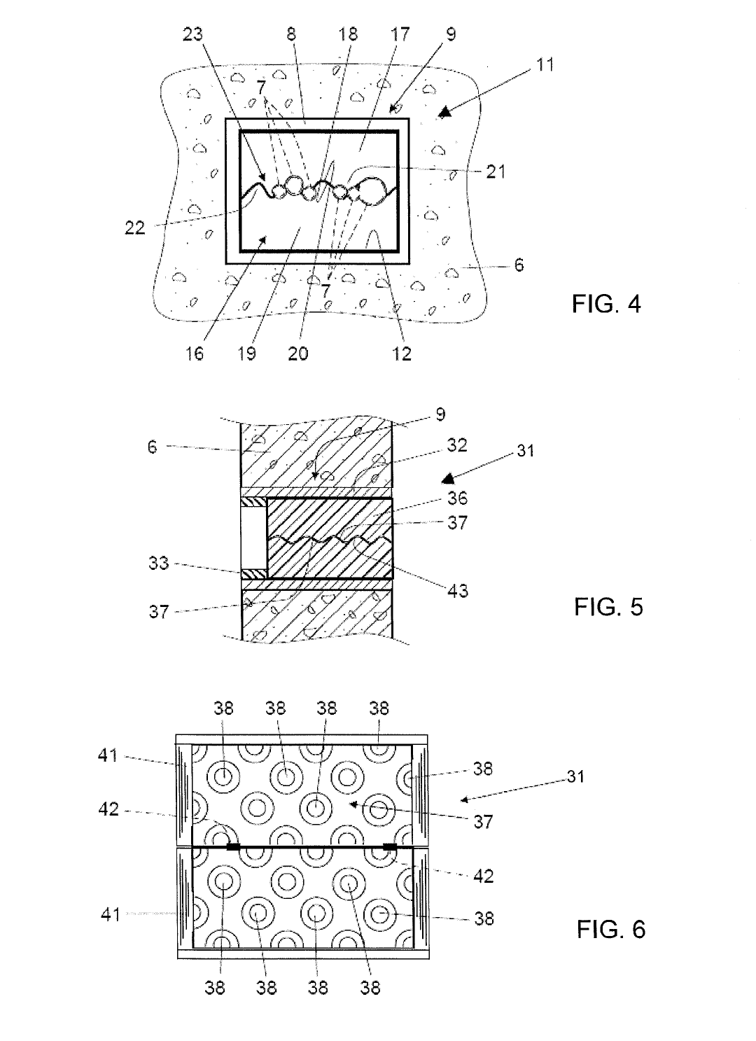

The device 11 depicted in FIG. 4 for receiving lines that have different diameters as lines 7 in a lead-through 9 of a wall as the component 6 has a jacket-like housing 12, a sealing insert 16 made of an elastically deformable material and a receiving area 23 for the lines 7. The sealing insert 16 has two sealing elements 17 and 19, each of which has a surface 18 and 20 provided with nubs 21 or 22 projecting into the axial projection of the receiving area 23. The nubs 21 or 22 are arranged intermittently along lines in the transverse direction of the jacket-like housing 12. Opposing nubs 21 or 22 are configured to be complementary in relation to the receiving area 23. In an assembled state, the sealing insert 16 completely fills in the cross-sectional volume of the jacket-like housing 12, thereby bulkheading the receiving area 23 so that it is impermeable to smoke-gas when the sealing insert 16 is in an assembled state. The sealing insert 16 is airtight and fabricated from an elastomer foam, such as, for example, polyurethane. Provided on the outside of the component 6 is a fire protection frame 8 having an intumescent insert, which completely seals the device 11 when a specific temperature level is reached.

Because of the elastic deformability of the sealing insert 16 and the nubs 21 and 22, it is possible for the device 11 to be subsequently occupied with additional lines 7. In addition, lines 7 that have been fed through the device 11 are able to be removed simply, wherein the sealing insert 16 expands in this region and the free space created by the removed line 7 is again sealed so that it is impermeable to smoke gas.

The device 31 depicted in FIGS. 5 and 6 has a tubular sleeve as a jacket-like housing 32. The sealing insert 36 includes two jacket sections 41 configured as half-shells, which encompass the sealing insert 36 on the outside in sections and are connected to each other via joints 42. The nubs 38 are arranged intermittently and offset from one another along lines in the longitudinal and transverse direction of the jacket-like housing 32. The opposing nubs 38 are configured to be complementary in relation to the receiving area 43. In an assembled state, the nubs 38 project into the axial projection of the receiving area 43 and seal it so that it is smoke-gas-proof. The sealing insert 36 is airtight and fabricated of a partially closed-cell foam. A fire protection insert 33 is further provided in the housing 32, and the insert completely seals the device 31 when a certain temperature level is reached.

For example, during a first step, the tubular housing 32 is arranged in the sheathing in the concrete wall prior to pouring. Then the lines are fed through the housing 32. The sealing insert 36 is then placed around the lines outside the component 6 in such a way that the surface 37 of the sealing insert 36 provided with nubs 38 encloses it and the receiving area 43 for the lines is formed. Then, the sealing insert 36 can be moved until it comes to lie in the housing 32. Because of the relationship of the inside diameter of the tubular housing 32 to the overall volume of the sealing insert 36, the device 31 is sealed so that it is impermeable to smoke gas. The housing 32 holds the sealing insert 36 in position via the jacket sections 41 so that it is possible to subsequently remove and feed lines through.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fire protection element for a smoke-gas-proof and fire-resistant bulkheading of a line lead-through, comprising:
a flat molded body of an elastically deformable material with a structured surface.

2. The fire protection element according to claim 1, wherein the flat molded body has a rectangular block shape and wherein the structured surface is a top surface of a base of the flat molded body.

3. The fire protection element according to claim 2, wherein the structured surface includes projecting elements that are arranged regularly or irregularly.

4. The fire protection element according to claim 3, wherein the projecting elements have different or similar geometries and/or dimensions.

5. The fire protection element according to claim 3, wherein the projecting elements are pyramidal, conical, hemispherical, or nubby.

6. The fire protection element according to claim 2, wherein the structured surface includes projecting elements and wherein the projecting elements are arranged intermittently along lines of the structured surface.

7. The fire protection element according to claim 1, wherein the structured surface includes elevations and depressions and wherein the elevations and depressions form grooves.

8. The fire protection element according to claim 7, wherein the grooves are undulated, trapezoidal, or wedge-shaped in a direction of a thickness of the fire protection element.

9. The fire protection element according to claim 7, wherein the grooves are rectilinear, undulated, trapezoidal, or wedge-shaped in a direction of a plane of the fire protection element.

10. The fire protection element according to claim 7, wherein the elevations have a same or a different height.

11. The fire protection element according to claim 10, wherein the height is different in an alternating or irregular manner.

12. The fire protection element according to claim 1, wherein the molded body is made of a foamable binding agent which contains an ash-forming and intumescent mixture.

13. The fire protection element according to claim 1, wherein the molded body includes a carrier element.

14. The fire protection element according to claim 1, further comprising a second flat molded body of an elastically deformable material with a second structured surface, wherein the structured surface of the flat molded body faces the second structured surface of the second flat molded body.

15. The fire protection element according to claim 14, wherein the structured surface of the flat molded body and the second structured surface of the second flat molded body are complementary.

16. The fire protection element according to claim 1, wherein the flat molded body is made at least partially of an ash-forming and intumescent mixture.

17. A method for sealing a lead-through of a component, comprising the steps of:
disposing a fire protection element in the lead-through of the component, wherein the fire protection element is a flat molded body of an elastically deformable material with a structured surface.

18. A device for receiving a line in a lead-through of a component, comprising:
a jacket-like housing with a sealing insert, wherein the sealing insert is a flat molded body of an elastically deformable material with a structured surface.

19. The device according to claim 18, wherein the structured surface includes a projecting element that projects into a receiving area of the sealing insert.

20. The device according to claim 18, wherein the structured surface includes elevations and depressions which are complementary.
